(19) United States
(12) Patent Application Publication
(10) Pub. No.: US 2005/0116876 A1
(43) Pub. Date: Jun. 2, 2005

(54) Distribution system for antenna array

(76) Inventor: Calin Moldoveanu, Ontario (CA)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/486,999

(22) PCT Filed: Aug. 13, 2002
(86) PCT No.: PCT/CA02/01255

(30) Foreign Application Priority Data
Aug. 14, 2001 (US) 60311827

(51) Int. Cl. H01Q 3/24

(52) U.S. Cl. 343/876

(57) ABSTRACT

An antenna distribution system provides an effective way to deploy wireless access coverage in an evolving subscriber coverage area. The antenna distribution system includes multiple levels of inputs that are selectively connected to an antenna array to alter the radiation pattern of the antenna array as desired for a given subscriber distribution and topography scenario. An eight-antenna array has four levels of input. The first level has eight inputs each selectively coupled to the corresponding one of the eight antenna. The second level has four inputs, each selectively coupled to two adjacent antennas. The third level has two inputs, each selectively coupled to four adjacent antennas. The fourth level has one input selectively coupled to all eight antenna. Phase shifters coupled to each antenna apply appropriate phase compensation for the antennas to effect the desired radiation pattern when coupled using the second, third or fourth level inputs. In general for n levels of input N=2ⁿ antennas are required, each antenna radiating a petal having an angle of 360°/2^{n-k} where k=O, 1 . . . n

### FIELD OF THE INVENTION

The present invention relates to a distribution system for antenna array.

### BACKGROUND OF THE INVENTION

As wireless point-to-multipoint systems are deployed to provide “last mile” connectivity to telecommunication service. Issues with effectively covering subscriber areas run into many practical problems. For example, in a developing market, when provisioning new network access with few initial customers one must constantly balance start up cost and down stream upgrade cost to strike a reasonable balance. To this one must also take into account complications due to physical geography of a given subscriber area.

One major system design component for wireless access is the antenna system. A major issue is how to provide coverage for both current customers and future growth, while optimizing the hardware utilization versus maintenance/upgrade costs tradeoff.

### SUMMARY OF THE INVENTION

An object of the present invention is to provide an improved distribution system for antenna array.

In accordance with an aspect of the present invention there is provided an antenna distribution system comprising a first plurality of inputs for connection to a radio frequency transceiver, a second plurality of inputs for connection to a radio frequency transceiver, a first plurality of switches, each switch selecting between one of the first plurality of inputs and a corresponding one of the second plurality of inputs for coupling the selected input to corresponding antenna.

In accordance with another aspect of the present invention there is provided an antenna distribution system comprising a first plurality of inputs for connection to a radio frequency transceiver, a second plurality of inputs for connection to a radio frequency transceiver, a first plurality of switches, each switch selecting between one of the first plurality of inputs and a corresponding one of the second plurality of inputs for coupling the selected input to corresponding antenna, a third plurality of inputs for connection to a radio frequency transceiver and a second plurality of switches, each switch selecting between one of the second plurality of inputs and a corresponding one of the third plurality of inputs for coupling the selected input to corresponding antenna.

In accordance with a further aspect of the present invention there is provided an antenna distribution system comprising a first plurality of inputs for connection to a radio frequency transceiver, a second plurality of inputs for connection to a radio frequency transceiver, a first plurality of switches, each switch selecting between one of the first plurality of inputs and a corresponding one of the second plurality of inputs for coupling the selected input to corresponding antenna, a third plurality of inputs for connection to a radio frequency transceiver and a second plurality of switches, each switch selecting between one of the second plurality of inputs and a corresponding one of the third plurality of inputs for coupling the selected input to corresponding antenna, a fourth plurality of inputs for connection to a radio frequency transceiver and a third plurality of switches, each switch selecting between one of the third plurality of inputs and a corresponding one of the fourth plurality of inputs for coupling the selected input to corresponding antenna.

### BRIEF DESCRIPTION OF THE DRAWINGS

FIGS. 1a and 1b graphically illustrate multi-antenna radiation patterns for four and eight antennas;

FIG. 2 graphically illustrates a multi-antenna radiation pattern for a mixed geometry antenna system;

FIG. 3 illustrates an antenna distribution system in accordance with an embodiment of the present invention; and

FIG. 4 illustrates in a block diagram the distribution network of FIG. 3.

### DETAILED DESCRIPTION OF THE PREFERRED EMBODIMENT

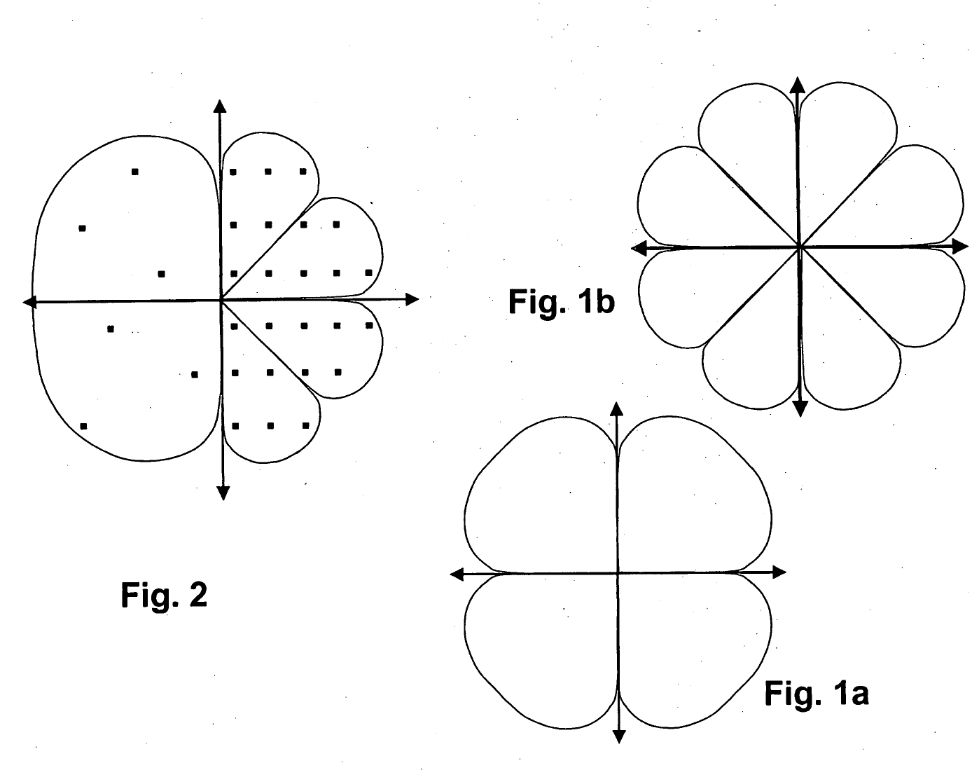

Referring to FIGS. 1a and 1b, there are graphically illustrated multi antenna radiation patterns for four and eight antennas, respectively. FIG. 1a represents a typical startup access configuration where each antenna services up to n subscribers, by dividing the coverage area into four quadrants, a potential of 4n subscribers can be serviced before the antenna system needs to be upgraded. Depending upon factors such as market share and population base, a future upgrade may increase capacity either to an expected level within a given timeframe, or may be based upon an estimate of the total expected subscription level. FIG. 1b represents a simple doubling of capacity by replacing the four 90° antennas with 8-45° antennas. Hence if each antenna can support n subscribers, the configuration of FIG. 1b can support 8n subscribers.

FIGS. 1a and 1b only address a simple capacity increase issue in an idealized environment. FIGS. 1a and 1b, greatly simplify the practical issues involved in antenna system deployment. These issues include local topography, population distribution, subscribers base, market share, growth potential.

FIG. 2 graphically illustrates a multi antenna radiation pattern for a mixed geometry antenna system. The coverage pattern of FIG. 2, would be typical of a subdivision/country estate or town/rural area where relatively high density was required for half of the coverage area and relatively low density for the other half. If the situation represented in FIG. 2 is a relatively stable one, for example a small town surrounded by farmland, deployment of one 180° antenna and four 45° antennas may represent a simple and cost effective solution. However, if the entire coverage area is suburban with the left two quadrants merely representing a new area being built up, this solution will only be a temporary one at best and will require replacement of the 180° antenna with two 90°, then four 45° antennas as the area is built up and subscribers are added. In this situation, a service provider must incur upgrade costs as the subscriber base grows, or anticipate the full potential growth. Unfortunately, antenna costs are only a part of the equipment costs involved with “over equipping” a subscriber area. For example, the radiated power is budgeted such that an operator cannot afford to waste radiated power by over providing a given area.

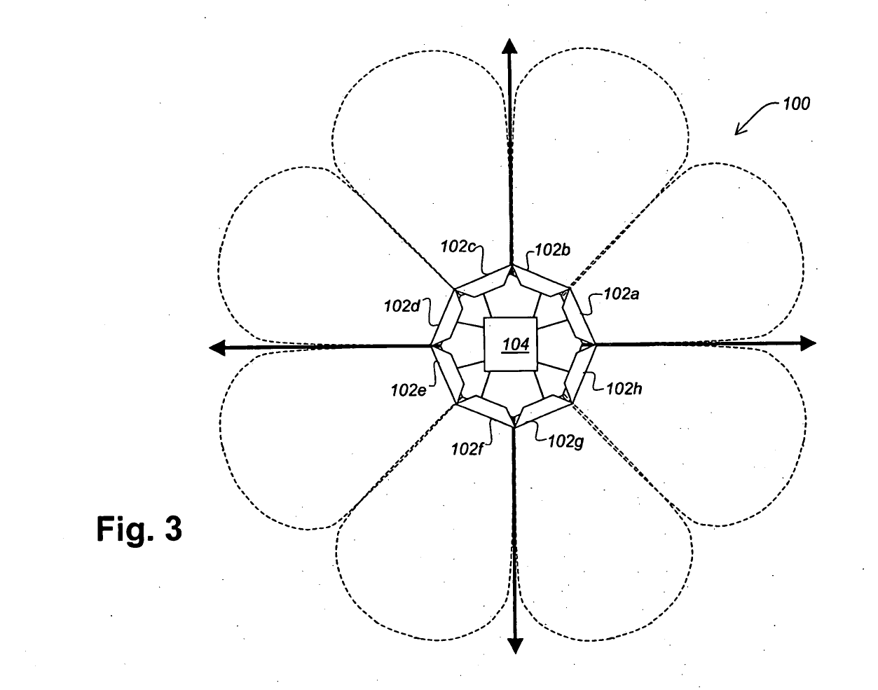

Referring to FIG. 3 there is illustrated an antenna distribution system in accordance with an embodiment of the present invention. The antenna distribution system 100 is connected to N(N=8) directive antennas 102a-102h, radially oriented to provide 360° coverage of the intended subscriber area. The antenna distribution system 100 also includes a distribution network 104. The distribution network provides an antenna configuration switch.

In operation, the antenna distribution system works in conjunction with a number N=2ⁿ identical directive antennas radially oriented. Depending on the number of potential customers in a certain sector of the point to multipoint rosette, it can create petals with angle 360/2^{n-k} with k ranging from 0 to n. (angle 360°/N to 360°). Regardless of the magnitude of the petal angle, the EIRP will be the same for all petals. However the achievable range will decrease by approximately 40% with each doubling of the petal angle due to the decreasing of the antenna gain. The setting of the petal angle can be done during the installation or at any later date.

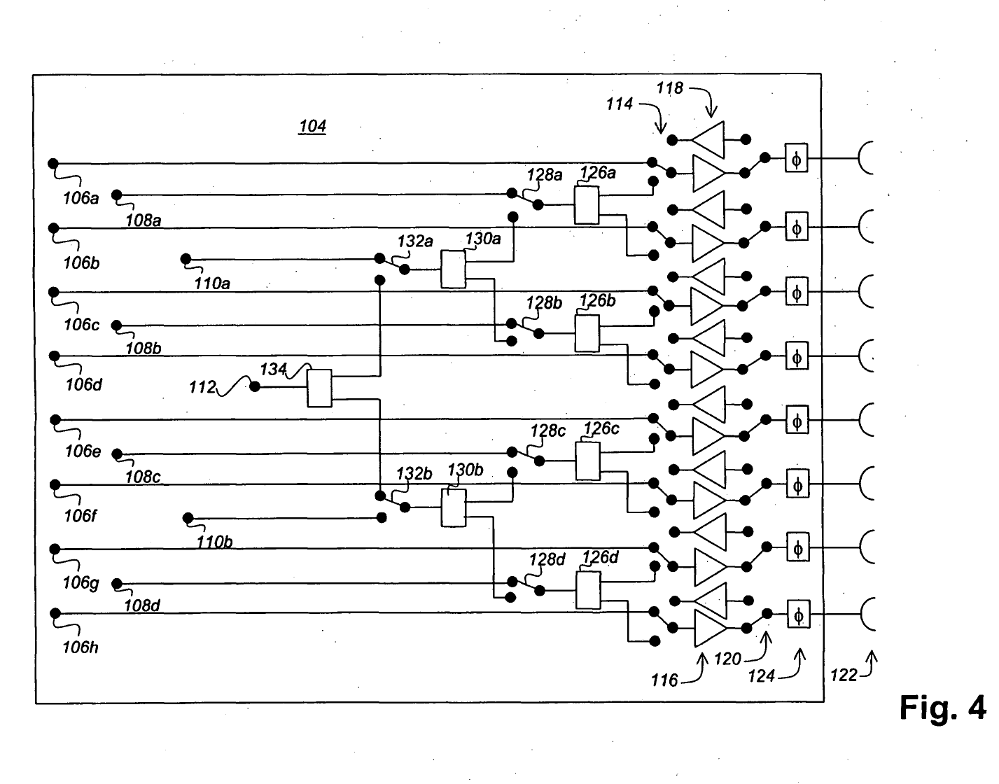

Referring to FIG. 4 there is illustrated in a block diagram the distribution network of FIG. 3. The distribution network 104 includes a plurality of first level inputs 106a-h, a plurality of second level inputs 108a-d, a plurality of third level inputs 110a-b and a fourth level input 112. Inputs 106a-h are directly connected to switch array 114. The switch array 114 effects connection between inputs and output power amplifiers 116a-h and low noise amplifiers 118a-h for transmission and reception, respectively. Power amplifiers 116a-h are connected via a second array of switches 120a-h to antenna 122a-h via phase shifters 124a-h. Second level inputs 108a-d are coupled to second level splitters 126a-d via a second level switch array 128a-d. Similarly, third level inputs 110a-b are coupled to third level splitters 130a-b via third level switches 132a and 132b. The fourth level input 112 is coupled via fourth level splitter 134 to the second level switches 132a-b.

In operation, the distribution network 104 allows signals to be input at the various levels and coupled to corresponding antennas to affect different distribution patterns. For example, 8 inputs could be used with first level inputs 106a-h each connected to a corresponding one of the eight antennas 122a-h (as shown in FIG. 4) thereby providing an eight petal distribution to the subscriber area as shown in FIG. 3. To effect a distribution as shown in FIG. 2, one of the third level inputs would be used together with four of the first level inputs. For example, third level input 110a could be used to provide the 180° coverage on the left hand side of FIG. 2, while first level inputs 106e-h would be used to provide the four 45° petals on the right hand side of FIG. 2. When the level two, three or four level inputs are used appropriate phase adjustment is provided by phase shifters 124a-h in order to simulate the coverage pattern of a single antenna with the equivalent petal angle.

The antenna distribution system (ADS) can be built to any desired size N. For example with N=32, the ADS can select:
Inputs on drive level 1 to drive 1 antenna each;
Inputs on drive level 2 to drive 2 antennas each;
Inputs on drive level 3 to drive 4 antennas each;
Inputs on drive level 4 to drive 8 antennas each;
Inputs on drive level 5 to drive 16 antennas each; and
Inputs on drive level 6 to drive 32 antennas each.

Or in general: inputs on drive level k to drive 2^{k-1} antennas each. Drive levels can be combined. For example, one antenna input/output from drive level 5 can be combined with 16 antenna inputs/output of drive level 1. Drive level 5 will generate a 180° petal and 16 drive level 1 antennas will each generate 11.25° petals.

Each petal has only one frequency band. Petal angle can be set at the installation at 11.25° or 22.50 or 45° or 90° or 180° or 360° depending on the number of customers in a certain sector.

| Drive Level | Number of Inputs | Antenna Gain | Petal Angle |
|---|---|---|---|
| 5 | 1 | 11 dB | 360° |
| 4 | 2 | 14 dB | 180° |
| 3 | 4 | 17 dB | 90° |
| 2 | 8 | 20 dB | 45° |
| 1 | 16 | 23 dB | 22.5° |

Numerous modifications, variations and adaptations may be made to the particular embodiments of the invention described above without departing from the scope of the claims, which is defined in the claims.

1. Antenna distribution system comprising:
a first plurality of inputs for connection to a radio frequency transceiver;
a second plurality of inputs for connection to a radio frequency transceiver;
a first plurality of switches, each switch selecting between one of the first plurality of inputs and a corresponding one of the second plurality of inputs for coupling the selected input to corresponding antenna.

2. A system as claimed in claim 1 further comprising a first plurality of phase shifters, each couple to a corresponding antenna.

3. A system as claimed in claim 2 wherein the phase shifter are controlled in dependence upon the input selected.

4. A system as claimed in claim 1 further comprising a third plurality of inputs for connection to a radio frequency transceiver and a second plurality of switches, each switch selecting between one of the second plurality of inputs and a corresponding one of the third plurality of inputs for coupling the selected input to corresponding antenna.

5. A system as claimed in claim 4 further comprising a first plurality of phase shifters, each couple to a corresponding antenna.

6. A system as claimed in claim 5 wherein the phase shifter are controlled in dependence upon the input selected.

7. A system as claimed in claim 4 further comprising a fourth plurality of inputs for connection to a radio frequency transceiver and a third plurality of switches, each switch selecting between one of the third plurality of inputs and a corresponding one of the fourth plurality of inputs for coupling the selected input to corresponding antenna.

8. A system as claimed in claim 7 further comprising a first plurality of phase shifters, each couple to a corresponding antenna.

9. A system as claimed in claim 8 wherein the phase shifter are controlled in dependence upon the input selected.
